(19) United States
(12) Patent Application Publication
(10) Pub. No.: US 2017/0131532 A1
(43) Pub. Date: May 11, 2017

(54) STAMPED SOLAR COLLECTOR CONCENTRATOR SYSTEM

(71) Applicant: NANOPRECISION PRODUCTS, INC., El Segundo, CA (US)

(72) Inventor: Rand DANNENBERG, Newbury Park, CA (US)

(21) Appl. No.: 15/236,381

(22) Filed: Aug. 12, 2016

Related U.S. Application Data
(60) Provisional application No. 62/204,277, filed on Aug. 12, 2015.

(51) Int. Cl. G02B 19/00; B21D 22/02; H02S 40/22

(52) U.S. Cl. CPC G02B 19/0023; H02S 40/22; G02B 19/0042; B21D 22/02

(57) ABSTRACT

A solar collector concentrator having a generally hollow, tubular structure that is precision stamped to form a highly reflective inside surface conforming to a geometry that facilitates concentrating incident light/radiation to the output end. The concentrator may be a separate component separately formed by stamping a malleable stock material. The concentrator may be coupled to the base of a reflector in the collector. The concentrator and the reflector may be integrally formed together by stamping a malleable stock material. The relative positions of the integrally defined concentrator and the reflector are therefore passively aligned with high accuracy achieved from precision stamping. The secondary reflector may be formed by stamping.

### PRIORITY CLAIM

This application claims the priority of U.S. Provisional Patent Application No. 62/204,277 filed on Aug. 12, 2015. This application is fully incorporated by reference as if fully set forth herein. All publications noted below are fully incorporated by reference as if fully set forth herein.

### BACKGROUND OF THE INVENTION

Field of the Invention

The present invention relates to solar collectors, in particular concentrators in solar collectors, and more particularly concentrated photovoltaic (CPV) in connection with generating photovoltaic energy.

Description of Related Art

Solar energy collectors provided with a Cassegrain-type optical system for concentrating the solar radiation captured through a collector of relatively large dimensions in a receiver of relatively small dimensions are well known. In this type of collector, a primary concave reflector is arranged to reflect and concentrate the captured solar radiation towards a secondary smaller convex reflector, which is located above the primary reflector and arranged in turn to reflect and concentrate the solar radiation from the primary reflector towards the receiver through a central opening existing in the primary reflector. The collector can be a device for the exploitation of thermal energy or a photovoltaic cell for converting solar energy into electricity. The Cassegrain optical system is advantageous in that it allows for a high concentration ratio between the collector area and the receiver area, with a small focal length, which allows for structuring solar energy collectors/concentrators of a relatively small volume and high performance.

A non-imaging concentrator may be deployed to focus solar energy onto a solar cell. The surface area of the solar cell in such a concentrator system is much smaller than what is required for non-concentrating systems, for example less than 1% of the input area of the concentrator.

Such a system has a high efficiency in converting solar energy to electricity due to the focused intensity of sunlight, and also reduces cost due to the decreased surface area of costly photovoltaic cells.

US20090101207A1 describes a concentrator in the form of a solid frustopyramidal radiation guide made of a transparent material to guide light from the secondary reflector to the photovoltaic cell. Light is guided through the solid material of the radiation guide by reflecting off the solid-air interface at the surface of the guide.

A drawback of the prior art solar energy collector is that the primary reflector, the secondary reflector and the concentrator are separate components that need to be accurately positioned relative to each other. In particular, the concentrator needs to be accurately positioned relative to the central opening in primary reflector, such that the concentrator is oriented and aligned with respect to the secondary reflector, which is in turn aligned with respect to the primary reflector. Alignment and/or orientation errors would result in loss of effectiveness of the collector. Further, the material of a solid radiation guide attenuates light, thus reducing the efficiency of the concentrator.

There remains the need to improve the performance and reliability of solar concentrators, and an improved process to produce solar concentrators with improved structural characteristics, functionalities, performances, reliability and manufacturability, at reduced costs.

### SUMMARY OF THE INVENTION

The present invention improves over the prior art concentrators used in solar collectors, by providing a solar collector concentrator having a generally hollow, tubular structure that is precision stamped to form a highly reflective inside surface conforming to a geometry that facilitates concentrating incident light/radiation to the output end.

In one embodiment of the present invention, the concentrator is a separate component separately formed by stamping a malleable stock material (e.g., a ductile metal stock), and subsequently positioned with respect to the reflector(s) in the collector.

In another embodiment of the present invention, the concentrator is coupled to the base (central region) of a reflector in the collector. In a further embodiment, the concentrator and the reflector are integrally formed together by stamping a malleable stock material (e.g., a ductile metal stock), to integrally defined the concentrator and the reflector from the same piece of stock material (i.e., the concentrator and the reflector are part of a homogeneous monolithic structure). In this embodiment, there is no joint (e.g., weld, solder, glue, and other attachment means and/or material) at the coupling between the reflector and the concentrator. The relative positions of the integrally defined concentrator and the reflector are therefore passively aligned with high accuracy achieved from precision stamping.

In a further embodiment, the secondary reflector may be formed by stamping.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1A is a photographic image of an array of photovoltaic collectors in accordance with one embodiment of the present invention; FIG. 1B is a schematic diagram of a collector in accordance with one embodiment of the present invention; and FIG. 1C is a schematic sectional view illustrating the Cassegrain-type optical path leading to the concentrator in the collector.

FIGS. 2A-2C illustrate concentrators in accordance with various embodiments of the present invention.

FIG. 3A is a perspective view of a concentrator in accordance with one embodiment of the present invention; and FIG. 3B is a sectional view taken along line 3B-3B in FIG. 3A.

FIG. 4A is a schematic diagram of a collector in accordance with another embodiment of the present invention; and FIG. 4B is a schematic sectional view illustrating the Cassegrain-type optical path leading to the concentrator in the collector.

### DETAILED DESCRIPTION OF THE PREFERRED EMBODIMENTS

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention.

The present invention provides a solar collector concentrator having a hollow structure that is precision stamped to form a highly reflective inside surface.

The present invention will be discussed below in connection with the embodiment of photovoltaic collectors. However, besides generating electricity by photovoltaic, the present invention is widely applicable to other purposes for solar energy collection, such as harnessing energy for heating, etc.

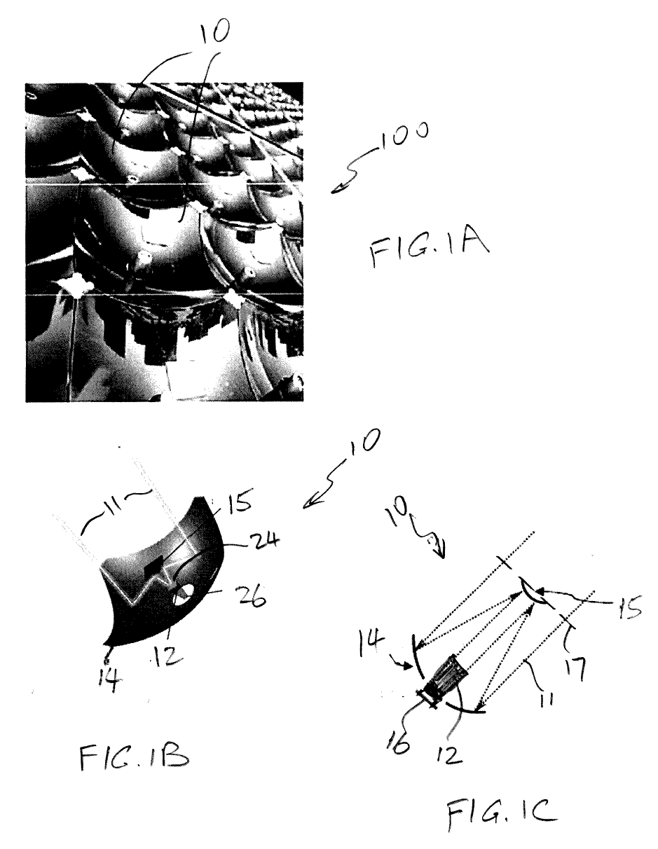

FIGS. 1A-1C illustrate collectors incorporating the inventive concentrator, in accordance with one embodiment of the present invention. FIG. 1 is a photographic image of a panel having an array 100 of photovoltaic collectors 10, each having a structure schematically depicted in FIG. 1B. FIG. 1C is a schematic diagram illustrating the Cassegrain-type optical path leading to the concentrator 12 in the collector 10.

Referring to FIGS. 1B and 1C, the collector 10 includes a primary concave reflector 14, a smaller secondary convex reflector 15 located above the primary reflector 14, and a hollow concentrator 12 in accordance with the present invention (will be discussed in detail below) at the base (central region) of the primary reflector 14 (as shown, the concentrator 12 is located through a central opening at the base of the primary reflector 14). The primary reflector 14 is arranged to reflect and concentrate captured incident solar radiation 11 towards the secondary reflector 15, which is arranged in turn to reflect and concentrate the solar radiation from the primary reflector 14 through the hollow concentrator 12. The concentrator 12 reflects and concentrates solar radiation towards a photovoltaic cell 16 for converting solar energy into electricity.

While not shown in the diagrams, the primary reflector 14, secondary reflector 15, concentrator 12 and photovoltaic cell 16 are supported by appropriate structures (not shown) by means known in the art. For example, such support structure may include stands, stamped or otherwise fabricated and assembled to support the various optical components in the Cassegrain configuration. For example, the secondary reflector 15 may be supported on a sheet of transparent material, e.g., Poly(methyl methacrylate) (PMMA), acrylic, Plexiglas, Lucite, glass, etc., which is placed across or covers the large opening of the primary reflector 14 (e.g., schematically represented by line 17 in FIG. 1C; which may be a plate supported on the edge/rim of the primary reflector 14).

Instead of, or in addition to, a photovoltaic cell, the collector 10 can be adapted to harness thermal energy for heating.

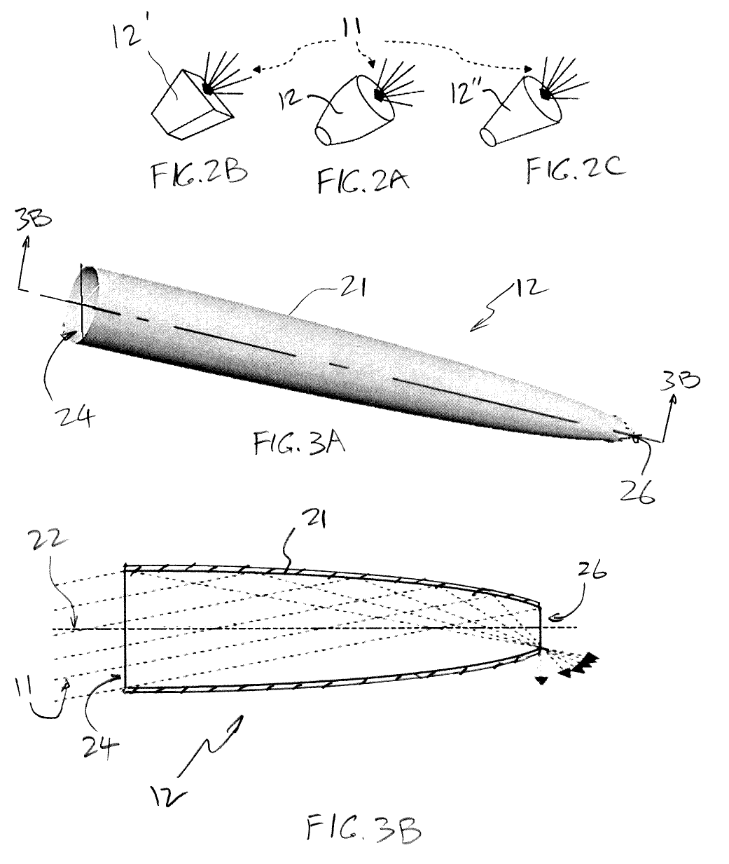

FIGS. 2A-2C illustrate concentrators in accordance with various embodiments of the present invention. FIG. 2A illustrates a hollow concentrator 12 having walls conforming to a parabolic profile (to be discussed in greater detail below); FIG. 2B illustrates a hollow concentrator 12′ having walls conforming to a frustopyramidal shape; and FIG. 2C illustrates a hollow concentrator 12″ having walls conforming to a frustoconical shape.

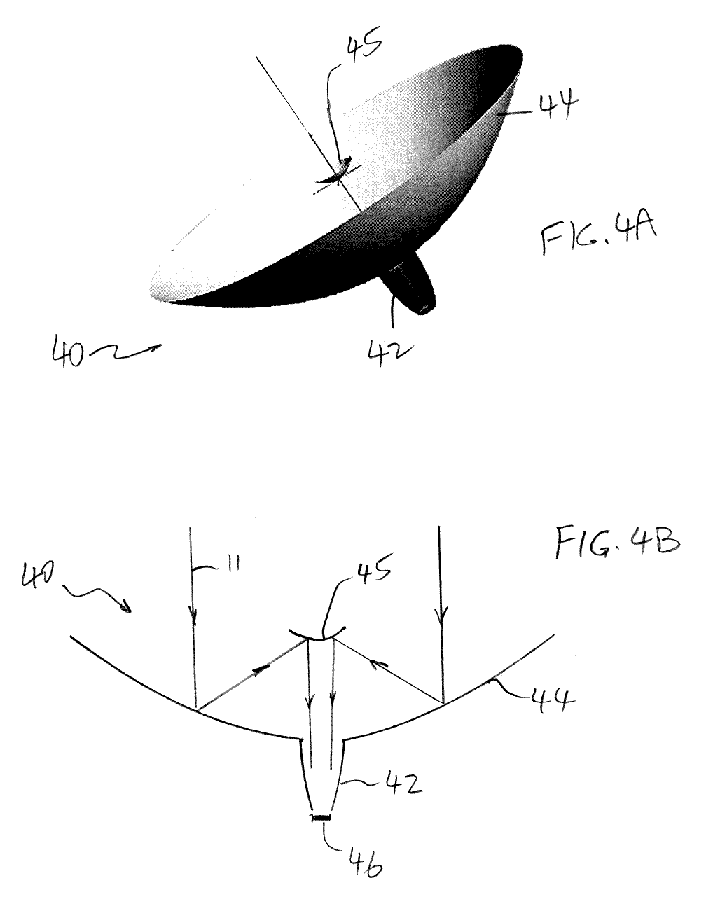

FIGS. 3A and 3B further illustrate the embodiment of the concentrator 12 in FIG. 2A. FIG. 3A is a perspective view of the concentrator 12, which has a thin walled hollow body defined by an axial-symmetric thin wall 21. The function of this concentrator 12 conforms to a compound parabolic concentrator. However, the performance and efficiency of the concentrator improve over the prior art concentrators. FIG. 3B is a sectional view along the axis 22, illustrating the wall 21 having a generally parabolic shape. The wall 21 may be deemed to conform to a parabolic surface of revolution about the longitudinal axis 22 of the concentrator 12 (i.e., a circular cross-section in a plane perpendicular to the axis 22). The concentrator 12 has a large entrance/input opening 24 at one end and a small exit/output opening 26 at another end. Light/radiation from the secondary reflector 15 enters the concentrator 12 from the large opening 24 (at a max entrance angle Θ relative to the axis 22). The ratio of the area of the primary reflector 14 to the area of the entrance area of opening 24 the concentrator 12 may be on the order of 100, or more.

In accordance with the present invention, the inside surface of the wall 21 is highly reflective. The reflective inside surface of the wall 21 may be deemed to conform to a parabolic surface of revolution about the longitudinal axis 22 of the concentrator 12 (i.e., a circular cross-section in a plane perpendicular to the axis 22). Radiation 11 reflecting from the secondary reflector 15 and entering the opening 24 in the concentrator 12 is incident at a shallow angle to the inside surface of the wall 21, which reflects the radiation towards the small exit opening 26, thereby concentrating the radiation energy to a small region. The photovoltaic cell 16 outside the exit opening 26 receives the concentrated radiation and generates electricity in response thereto.

In accordance with one embodiment, the concentrator 12 may have the following physical parameters:
a. Length: 13.5 mm
b. Input diameter (opening 24): 1.64 mm
c. Output diameter (opening 26): 100 μm
d. Concentration Factor (CF): 270
e. Wall thickness: 0.1 to 5 mm
f. Blackbody Temp: 1260° C.
g. Θ(max entrance angle relative to axis 22): 3.5°

In another example, the concentrator 12 may have the following physical parameters:
a. Length: 13.5 mm
b. Input diameter (opening 24): 2 mm
c. Output diameter (opening 26): 90 μm
d. Concentration Factor (CF): 500
e. Wall thickness: 0.1 to 5 mm
f. Blackbody Temp: 1450° C.
g. Θ(max entrance angle relative to axis 22): 0.9°

In accordance with the present invention, the hollow structure of the concentrator 12 is precision stamped to form a highly reflective inside surface of the wall 21. U.S. Pat. No. 7,343,770,commonly assigned to the assignee of the present invention, discloses a novel precision stamping system for manufacturing small tolerance parts. Such inventive stamping system can be implemented in various stamping processes to produce the concentrator 12. These stamping processes involve stamping a malleable stock material (e.g., a ductile metal stock), to form the inside reflective surface feature having the desired parabolic geometry at tight (i.e., small) tolerances. Stamping may be configured in at least two approaches. In the first approach, the hollow tube-shaped structure of the concentrator 12 may be obtained by stamping as a depression in a sheet of stock material (e.g., metal ribbon stock). Alternative, the concentrator 12 may be stamped formed by “folding” or “rolling” a sheet of stock material. The former approach would be more suited for smaller size concentrators, and the latter approach would be better for larger size concentrators.

In one embodiment of the present invention, the concentrator 12 is a separate component separately formed by stamping a malleable stock material (e.g., a ductile metal stock), and subsequently positioned with respect to the primary reflector 14 in the collector 10 (as schematically illustrated in FIGS. 1B and 1C).

In another embodiment of the present invention, a collector 40 is configured with a concentrator 42 coupled to the base (central region) of a primary reflector 44 in the collector 40, as illustrated in FIGS. 4A and 4B. (The collectors 10 in FIG. 1A may be replaced with the collectors 40 of this embodiment). In this embodiment, the collector 40 includes a primary concave reflector 44, a smaller secondary convex reflector 45 located above the primary reflector 44, and a hollow concentrator 42 in accordance with another embodiment of the present invention at the base of the primary reflector 44. The primary reflector 44 and the secondary reflector 45 each has a circular periphery, instead of a square periphery as in the case of the primary reflector 14 and secondary reflector 15 in the earlier embodiment. The geometry of the concentrator 42 may be similar to that of the concentrator 12. Instead of extending the concentrator 12 through a central opening at the base of the primary reflector 14 in the earlier embodiment, the large entrance/input end of the concentrator 42 is coupled to the base of the primary reflector 44, such that the entrance opening 54 at the large end of the concentrator 44 opens into the central region/opening of the base of the primary reflector 44. As in the earlier embodiment, a photovoltaic cell 46 is positioned at the exit opening 56 of the concentrator 42.

In a further embodiment, the concentrator 42 and the primary reflector 44 are integrally formed together by stamping a malleable stock material (e.g., a ductile metal stock), to integrally defined the concentrator 42 and the primary reflector 44 from the same piece of stock material (i.e., the concentrator 42 and the primary reflector 44 are part of a homogeneous monolithic structure). The hollow tube-shaped structure of the concentrators 42 may be obtained by stamping as a depression in a sheet of stock material (e.g., metal ribbon stock). In this embodiment, there is no joint (e.g., weld, solder, glue, and other attachment means and/or material) at the coupling between the primary reflector 44 and the concentrator 42. The relative positions of the integrally defined concentrator 42 and the primary reflector 44 are therefore passively aligned with high accuracy achieved from precision stamping.

In one embodiment, an array of primary reflectors 44 each having an integral concentrator 42 may be formed together by stamping a sheet of malleable stock material to integrally defined the array of collectors 40 from the same piece of stock material (i.e., the collectors 40 each including a concentrator 42 and a primary reflector 44, are part of a homogeneous monolithic structure). The array 100 of collectors shown in FIG. 1A may be implemented with an array of collectors 40 of this embodiment. The center spacing between the primary reflectors 44 and the center spacing between the concentrators 42 can be accurately defined by the precision stamping process.

In addition, an array of secondary reflectors 45 may be formed together by stamping a sheet of malleable stock material. The center spacing of the secondary reflectors 45 can be accurately defined by the precision stamping process. With the array of secondary reflectors 45 connected in an array, the cost of a molded plastic cover to support the secondary reflectors may be eliminated.

In accordance with the present invention, the following benefits can be achieved:
a. Reduction of costs due to stamping.
b. Miniaturization of the reflectors to millimeter or micron scale to improve performance and efficiency of the solar collectors.
c. Miniaturization leading to lower overall thicknesses of panels and reflectors, thereby resulting in cost reduction from less material used.
d. Mirrors being made of metal to be used as heat sinks.
e. Metal reflectors may be provided with coolant circulating around them in channels to recapture what would be waste heat.
f. Miniaturization allowing stamped fluidic channels to be integrated into the panel.
g. Stamped ultra-high concentration factor (CF) mirrors (could reach 44,000) allowing huge areal reductions in the panels, and therefore less materials and less cost.
h. Ultra-high concentrations leading to more waste heat and therefore more recapture possible for water heating.
i. Stamping arrays of secondary mirrors in a single sheet to eliminate costs of molded plastic cover. The latter allowing the entire unit to be protected from the environment by a single glass sheet.
j. Miniaturization of the entire collector array (either by thickness or area), so it would weigh less. Consequently, the tracking system servo motors consume less energy moving the collector array.
k. Miniaturization of optics leading to miniaturization of the tracking system needed and resulting in further cost reduction.
l. Reflectors being made of metal allowing longer field life from environmental exposure, as compared to molded plastics.

* * *

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

I claim:

1. A solar energy collector, comprising:
a primary reflector,
a concentrator, having an input opening and an output opening, wherein the concentrator comprises a thin walled, hollow body stamped from a malleable metal stock material, wherein the body of the concentrator has an inside surface that is reflective, and wherein the concentrator is positioned with respect to the primary reflector, such that the primary reflector directs incident solar radiation to the input opening of the concentrator.

2. The solar energy collector as in claim 1, wherein the concentrator is positioned with respect to a central opening in the primary reflector.

3. The solar energy collector as in claim 2, wherein the concentrator is coupled to the primary reflector, with the input opening opens into the central opening of the primary reflector.

4. The solar energy collector as in claim 3, wherein the concentrator and the primary reflector are formed are integrally formed together by stamping a malleable metal stock material, to integrally defined the concentrator and the reflector from the same stock material, wherein relative positions of the integrally defined concentrator and reflector are passively aligned.

5. The solar energy collector as in claim 4, wherein the concentrator and the reflector are part of a homogeneous monolithic structure.

6. The solar energy collector as in claim 5, wherein there is no joint at the coupling between the reflector and the concentrator.

7. The solar energy collector as in claim 6, wherein the input opening of the concentrator is larger than the output opening of the concentrator.

8. The solar energy collector as in claim 7, further comprising a secondary reflector positioned with respect to the primary reflector and the input opening of the concentrator, such that the secondary reflector directs radiation from the primary reflector to the input opening of the concentrator.

9. The solar energy collector as in claim 8, wherein the secondary reflector is stamped from a malleable metal stock.

10. A solar energy collection panel, comprising a plurality of solar energy collectors as in claim 1, wherein a plurality of primary reflectors are integrally formed by stamping a malleable metal stock material.

11. A method of forming a solar energy collector, comprising:
providing a primary reflector,
stamp forming a concentrator, having an input opening and an output opening, wherein the concentrator comprises a thin walled, hollow body stamped from a malleable metal stock material, wherein the body of the concentrator has an inside surface that is reflective, and wherein the concentrator is positioned with respect to the primary reflector, such that the primary reflector directs incident solar radiation to the input opening of the concentrator.

12. The method as in claim 11, wherein the concentrator is positioned with respect to a central opening in the primary reflector.

13. The method as in claim 12, wherein the concentrator is coupled to the primary reflector, with the input opening opens into the central opening of the primary reflector.

14. The method as in claim 13, wherein the concentrator and the primary reflector are formed are integrally formed together by stamping a malleable metal stock material, to integrally defined the concentrator and the reflector from the same stock material, wherein relative positions of the integrally defined concentrator and reflector are passively aligned.

15. The method as in claim 14, wherein the concentrator and the reflector are part of a homogeneous monolithic structure.

16. The method as in claim 15, wherein there is no joint at the coupling between the reflector and the concentrator.

17. The method as in claim 16, wherein the input opening of the concentrator is larger than the output opening of the concentrator.

18. The method as in claim 17, further providing a secondary reflector positioned with respect to the primary reflector and the input opening of the concentrator, such that the secondary reflector directs radiation from the primary reflector to the input opening of the concentrator.

19. The method as in claim 18, wherein the secondary reflector is stamped from a malleable metal stock.

20. The method as in claim 11, comprising stamp forming a plurality of primary reflectors and concentrators integrally by stamping a malleable metal stock material, wherein each primary reflector is associated with a concentrator.
